(19) United States
(12) Patent Application Publication
(10) Pub. No.: US 2014/0078864 A1
(43) Pub. Date: Mar. 20, 2014

(54) INTRA-BED SOURCE VERTICAL SEISMIC PROFILING

(71) Applicant: David Fraga Freitas, Rio de Janeiro (BR)

(72) Inventor: David Fraga Freitas, Rio de Janeiro (BR)

(21) Appl. No.: 13/621,623

(22) Filed: Sep. 17, 2012

(51) Int. Cl. G01V 1/28; G01V 1/42

(52) U.S. Cl. 367/57

(57) ABSTRACT

A system and method obtain a Vertical Seismic Profile (VSP). The system includes a seismic source disposed in a first borehole at a first depth greater than an identified depth of a interface, the seismic source configured to emit seismic waves. The system also includes one or more receptors disposed in a second borehole that includes a target region of interest, the one or more receptors configured to receive direct and reflected components of the seismic waves.

### BACKGROUND

This invention is related to geophysical exploration and more specifically to a borehole seismic method of exploration

In the mineral and petroleum exploration field, for decades the utilization of geophysical methods has been imperative to map the subsurface, improve the capability of finding hydrocarbons, and reduce costs in exploration, drilling and production activities. In this sense, Reflection Seismic is the most broadly used geophysical method in petroleum exploration for mapping basin structures and potential reservoirs, because the method has the ability to record information from different layers disposed in the subsurface. Due to the fact that acoustic signals related to different layers arrive at different times, the reflection seismic technique is able to produce stratified mapping (1D, 2D and 3D) of huge sedimentary packages with significant detail. Besides the structural mapping, the study of seismic attributes (amplitude, reflection coefficient, frequency, impedance, velocity, etc.) is useful to better understand the physical properties and characterize a reservoir in large and middle scale.

The main reflection seismic methods applied in the oil industry are the surface seismic and borehole seismic techniques (Vertical Seismic Profiling). In surface seismic techniques, the signal is generated at the surface or near the surface, and is recorded by receivers also disposed at the earth surface or close to the sea level. In turn, in Vertical Seismic Profiling (VSP) the seismic source is usually located at or close to the surface and the receptors are coupled to the wall of a drilled well.

The reflection seismic method is based on the propagation of seismic waves or vibrations in the subsurface and a record of the subsequently reflected signals when the waves reach interfaces that separate layers with different physical properties. As the waves propagate through the earth's interior, part of the energy is reflected when the waves reach interfaces which separate layers with different densities and elastic coefficients, and the other part continues to propagate, reaching new interfaces and generating new reflections until all the energy is dispersed. The seismic signal is usually generated at the surface or near the surface, and can be recorded by receivers also disposed at the earth surface or close to the sea level (surface seismic) or by receivers placed in the wells (VSP technique).

When the seismic wave propagates through the subsurface, the seismic wave suffers several types of signal attenuation. These include: (1) attenuation due to spherical divergence as the traveled distance increases; (2) attenuation due to energy reflection and refraction; (3) attenuation by diffraction due to the rugous or irregular interfaces; and (4) high frequency attenuation with the earth acting as a low-frequency bandpass filter. In this sense, VSP, in comparison to conventional surface seismic methods, allows recording of more intense signals with less attenuation at higher based on the fact that the wave travel distance between the source and the in-well receptors is shortened (rather than requiring a round-trip to the surface). The better quality data recorded in VSP normally presents more resolution and allows the generation of more accurate seismic attribute data. Moreover, due to the fact the receivers are placed in the subsurface below the seismic sources, the method facilitates recording of both down-going and up-going events (whereas the surface seismic method can only record up-going events), and also facilitates accurate estimation of intra-bed velocities in a short interval and the direct correlation of the signal arrival time with the event positioning in the subsurface (where receiver positions in depth are known). However, when the target regions of interest are in very deep zones, superposed by layers whose interfaces present high acoustic impedance (e.g., salt and carbonate layers, basalt sills, etc.), the prior VSP technique, too, is insufficient because most of the seismic signal is attenuated/dispersed by highly reflective interfaces in the subsurface (e.g., sea bottom, salt top, salt base, carbonate platforms, basalt sills, etc.).

Thus, the mineral and hydrocarbons exploration industry would appreciate a technique that provides greater resolution in seismic imaging of targets located below thick sedimentary layers superposed by highly reflective interfaces.

### BRIEF SUMMARY

According to an embodiment, a system to obtain a Vertical Seismic Profile (VSP) includes a seismic source disposed in a first borehole at a first depth greater than an identified depth of a interface, the seismic source configured to emit seismic waves; and one or more receptors disposed in a second borehole that includes a target region of interest, the one or more receptors configured to receive direct and reflected components of the seismic waves.

According to another embodiment, a method of obtaining a Vertical Seismic Profile (VSP) includes disposing a seismic source in a first borehole at a first depth greater than an identified depth of a reflective interface, the seismic source being configured to emit seismic waves; and disposing one or more receptors in a second borehole that includes a target region of interest, the one or more receptors configured to receive direct and reflected components of the seismic waves.

According to yet another embodiment, a method of arranging a Vertical Seismic Profile (VSP) system includes identifying a reflective interface depth of a reflective interface in an area of interest; positioning a seismic source at a first depth, the first depth being below the reflective interface depth in a first borehole within the area of interest; and positioning two or more receptors in a second borehole within the area of interest, the receptors being clamped to the second borehole wall in selected positions to monitor a target region for seismic profiling.

### BRIEF DESCRIPTION OF THE DRAWINGS

The following descriptions should not be considered limiting in any way. With reference to the accompanying drawings, like elements are numbered alike:

FIG. 1 is a cross-sectional block diagram of an onshore Vertical Seismic Profiling (VSP) system according to an embodiment;

FIG. 2 is a cross-sectional block diagram of an offshore Vertical Seismic Profiling (VSP) system according to an embodiment;

FIG. 3 depicts a VSP system according to an embodiment including a vertical first borehole;

FIG. 4 depicts a VSP system according to an embodiment including a horizontal first borehole; and

FIG. 5 the processes involved in obtaining a seismic profile of a target region based on an embodiment.

### DETAILED DESCRIPTION

A detailed description of one or more embodiments of the disclosed apparatus and method presented herein by way of exemplification and not limitation with reference to the Figures.

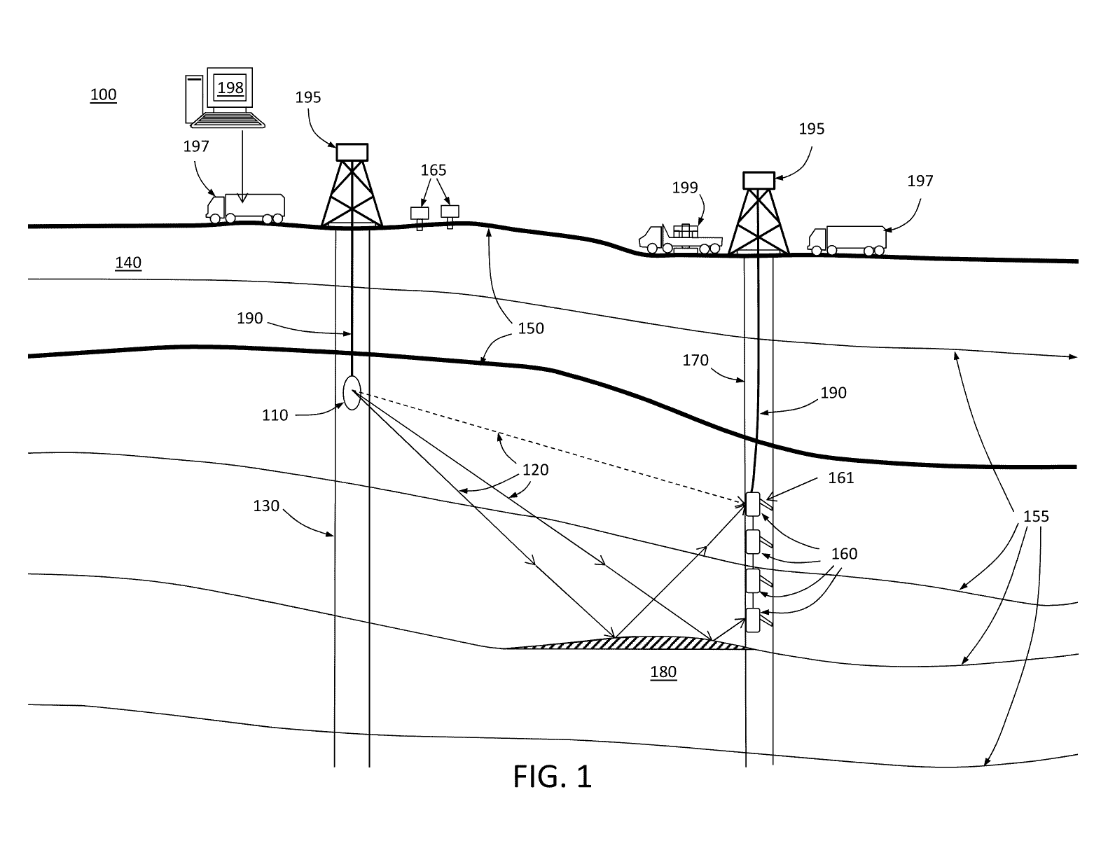

FIG. 1 is a cross-sectional view of an onshore Vertical Seismic Profiling (VSP) system 100 according to an embodiment. The exemplary VSP system 100 is shown to include one borehole seismic source 110 emitting a seismic wave 120. However, in alternate embodiments, two or more seismic sources 110 may be disposed in proximity of each other. The seismic source 110 may be an explosive, an air-gun, a sparkler, or some other known source of seismic signals 120 able to be fired in a borehole 130. The seismic source 110 is shown in a first borehole 130 penetrating the earth 140, which includes a target region 180 of interest. The seismic source 110 is disposed below the highly reflective interface 150 shown in FIG. 1. Relatively regular reflective interfaces 155 are also represented in the FIG. 1. The first borehole 130 may include special casing to support repeated shots performed by the seismic source 110 if necessary. The exemplary VSP system 100 is also shown to include four receptors 160 (or receivers) in a second borehole 170, different than the first borehole 130 that includes the seismic source 110. Either or both of the boreholes 130 and 170 may be deviated or horizontal. In that case, the trajectory and angle of the borehole (130, 170) must be measured and accounted for in the subsequent processing of the received signals.

As shown, the receptors 160 are disposed at a depth that is deeper than the depth at which the seismic source 110 is disposed. This allows the receptors 160 to receive both down-going seismic signal and the up-going primary reflected signals resulting from the seismic wave 120 emitted by the seismic source 110. In alternate embodiments, the receptors 160 may be positioned above the seismic source 110 if required for a specific case study. The receptors 160 are clamped to a preselected position of the borehole 170 wall (see exemplary clamping mechanism 161) to monitor the target region 180. The clamping may improve the quality of the recorded signals. The receptors 160 or array of receptors 160 are clamped to the borehole 170 wall during use but may be decoupled to be moved to another measuring position as needed. When receptors 160 are substantially equi-distant from each other, the received signals can be regularly sampled. Each receptor 160 may include, among other things, a single geophone, three-component geophones, vertical geophones, hydrophones, orientation measuring system, geophone-to-wall coupling measurement mechanism, downhole digitizing system, and a connection to other receptors 160. Additionally, each receptor 160 may include clamping mechanisms 161 as retractable locking arms, a telescoping ram, fixed bow spring, hydraulic pistons, or any other apparatus that may be used to clamp the receptor 160 to the borehole 170 wall. The seismic source 110 and the receptors 160 may be conveyed through the first borehole 130 and the second borehole 170, respectively, by carriers 190.

In various embodiments, the carrier 190 may be a drill string (for Seismic While Drilling applications) or armored wireline cable supported by a drill rig 195. The seismic source 110 and receptors 160 may be in communication, via telemetry, for example, with one or more acquisition units 197. The seismic source 110 and the receptors 160 need not share the same one or more acquisition units 197, which may include one or more memory devices, user interfaces, acquisition systems, positioning systems, source control systems, high precision clocks, etc. The acquisition unit 197 may control the seismic source 110 and record and process data from the receptors 160 using one or more processors 198. Additionally, surface receptors 165 may control the seismic signal 120 produced by the seismic source 110 and correct the data recorded downhole by the receptors 160 located in the borehole 170. The signals recorded by the surface receptors 165 may also be used to identify the influence that the layer above the seismic source 110 causes in the seismic signal 120 produced by this seismic source 110. Although FIG. 1 illustrates two surface receptors 165, only one or a number of surface receptors 165 may be used depending on the survey objectives.

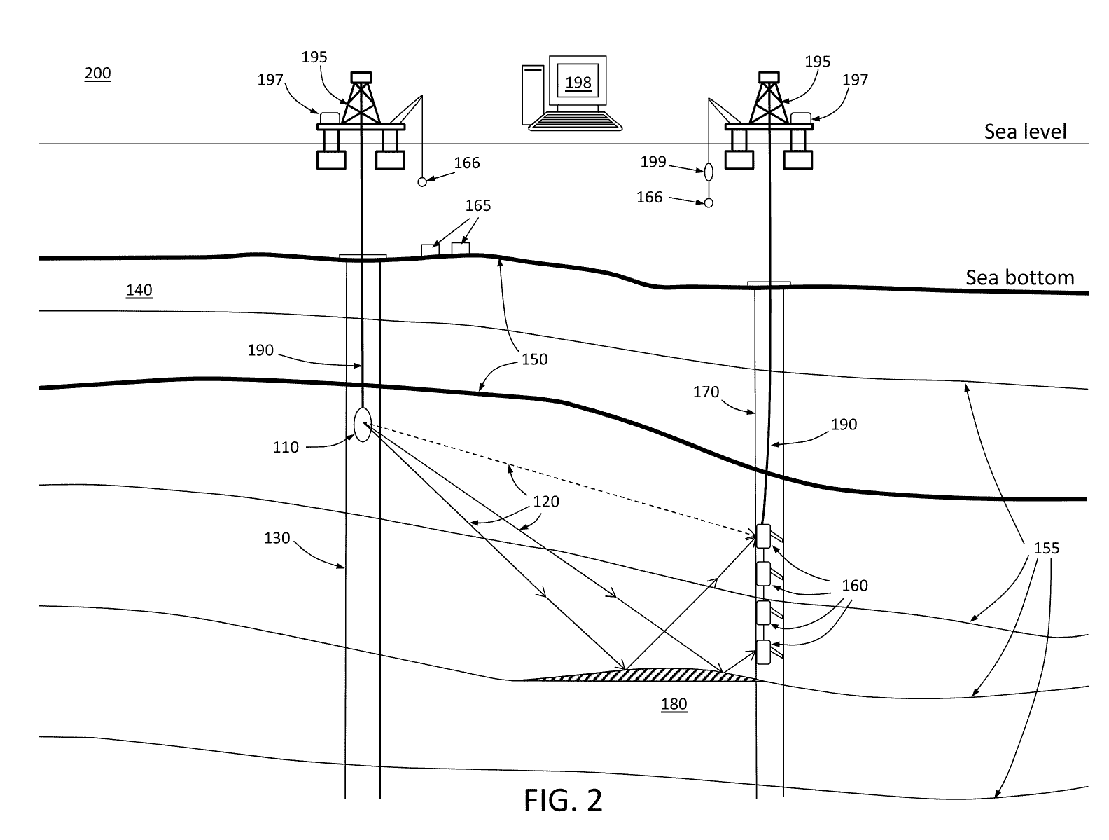

In alternate embodiments, the exemplary VSP system 100 described herein may be applied in Seismic While Drilling (SWD) surveys. In this case, the receptors 160 and carrier 190 in the borehole 170 will be utilized for SWD with the receptors 160 being able to record data while drilling coupled a drilling column. As noted above, the carrier 190 would be a drill string, for example. High precision clocks may be included in the seismic source 110 and in the receptors 160 to synchronize the shoot time and the reception time, and precisely record signal travel times. The exemplary VSP system 100 may be used onshore (FIG. 1), offshore (as shown in FIG. 2) or in water bodies (lakes, lagoons, rivers, etc.), in a variety of different depths and with different distances between the boreholes 130 and 170.

FIG. 2 is a cross-sectional block diagram of an offshore Vertical Seismic Profile (VSP) system 100 according to an embodiment. When the VSP system 100 is used offshore or in other places covered by water bodies, the receptors 165 need to be appropriated to work under water and clamped on the sea bottom or other water body bottom. Additionally in this case, one or more hydrophones 166 may be placed from the drill rig 195 (or alike) that supports the borehole seismic source 110 in the water and used to record the seismic signals 120 produced by the source 110 that cross the water column for better signal control and water column velocity calculations. Still in the case of using the VSP system 100 offshore or in other places covered by water bodies, a surface or near surface seismic source 199 may initially be used in the water to perform a conventional VSP survey to identify highly reflective interfaces 150 and regular reflective interfaces 155. In this case, a hydrophone 166 may be disposed in the water below the surface seismic source 199 for better monitoring the seismic signal produced by the surface seismic source 199. Alternatively, the VSP system 100 may be used to perform VSP surveys in a number of wells at the same time. In such embodiments, the seismic source 110 would be placed in a first borehole 130 surrounded by the other boreholes (e.g., 170). Additionally, receptors 160 would be placed in the boreholes (e.g., 170) that surround the first borehole 130. Each of the other boreholes (e.g., 170) where the receptors 160 are placed would include similar apparatus as in the borehole 170. Thus, when seismic signals 120 are produced by the seismic source 110 placed in the borehole 130, their resultant signals can be detected by the receptors 160 placed in the other boreholes (e.g., 170) surrounding the first borehole 130.

The one or more highly reflective interfaces 150 are identified and approximated prior to positioning the seismic source 110 to ensure that the seismic source 110 is positioned below a highly reflective interface 150 of interest. Typically, surface seismic data may have already been obtained in an area where the VSP survey is planned. Also, highly reflective interfaces 150 can be identified through the interpretation of well log data, such as acoustic logs, density logs, gamma ray logs, well velocity surveys (checkshot surveys), or others useful logs previously performed in the wells. The VSP system 100 itself may be used to identify the highly reflective interfaces 150. In alternate embodiments, the reflective interface 150 may be identified through interpretation of data obtained previously from a conventional VSP survey using a seismic source 199 at the surface or close to the surface. The data obtained by the receptors 160, recording seismic signals produced by the surface seismic source 199, is analyzed and interpreted to identify the highly reflective interfaces 150. Specifically, highly reflective interfaces 150 are identified as those areas where the amplitude of reflections (of seismic waves) is relatively higher than in other areas. Highly reflective interfaces are formed by contact between two layers having significant differences in physical properties (e.g., density, porosity, elastic coefficients, seismic velocity). These interfaces generate strong reflections that cannot necessarily be quantified for specific reflectivity or amplitude values (because they are identified by relative strength in a given area) but can be interpreted over the set of acquired data. Different examples of seismic data can present a large variation in the amplitude or reflectivity values. The seismic data may be recorded in 8, 16, or 32 bits, and different processing workflows or filters may be applied. For example, the minimum and maximum amplitude values observed in a typical seismic section can range between few hundreds (e.g. 8 bits data) or millions (e.g. 32 bits data). Thus, the interpretation of highly reflective interfaces in seismic data is usually based on the identification of reflections composed by relatively high amplitude (or reflectivity) values, compared to the general context of the data. Specific algorithms and software are used to interpret seismic data. Besides amplitude and reflectivity, other seismic attributes can be used to identify such highly reflective interfaces 150, as well. As noted above, seismic attributes include reflection coefficient, frequency, impedance, and velocity.

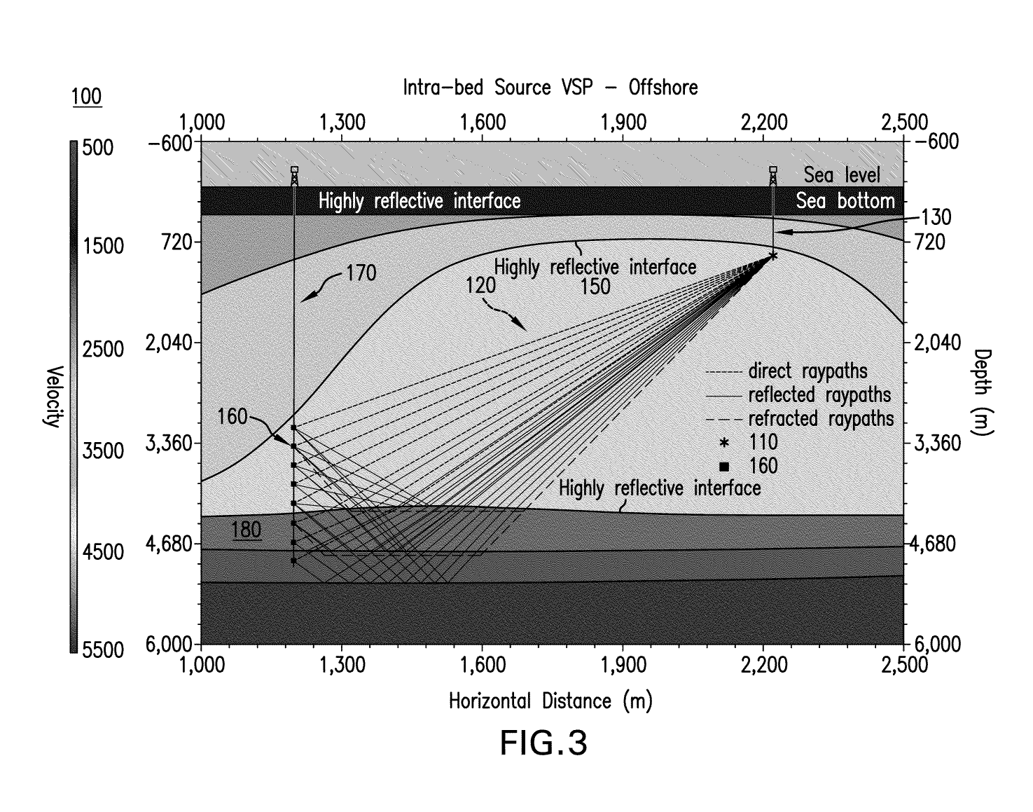

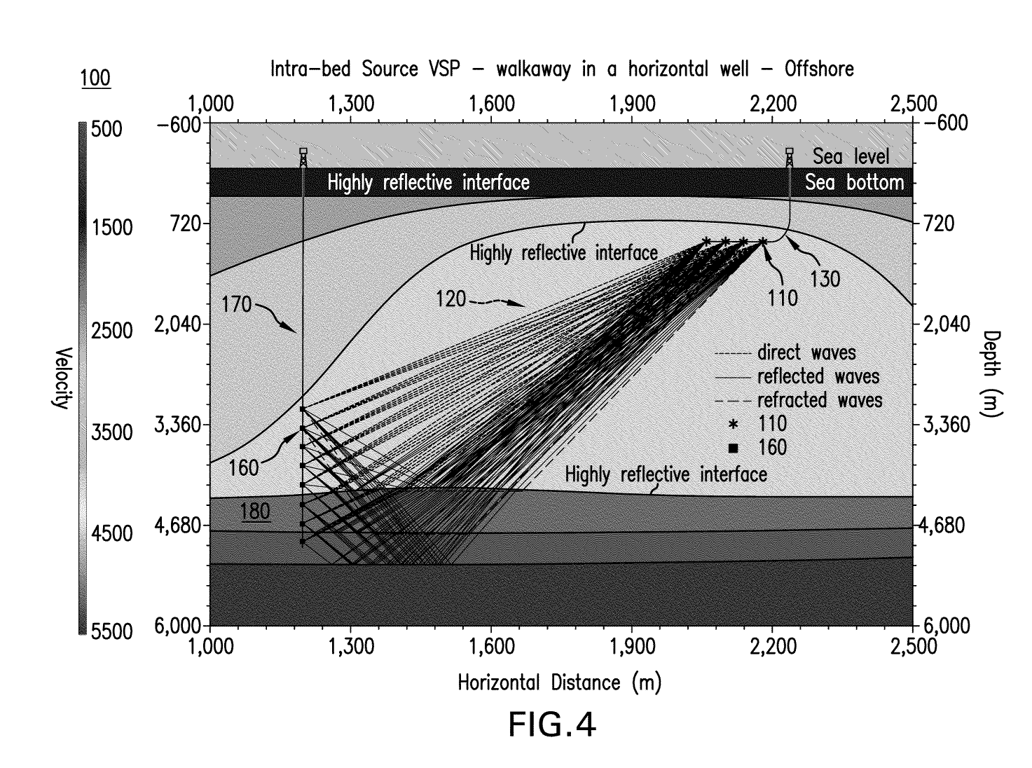

FIG. 3 depicts a VSP system 100 according to an embodiment including a vertical first borehole 130. Although FIG. 3 shows one seismic source 110, there may be two or more seismic sources 110 below the highly reflective interface 150. Also, in alternate embodiments, the seismic source 110 or multiple seismic sources 110 may be moved along the borehole 130 and, additionally or alternatively, the seismic source 110 may rotate in place to alter the direction of the output seismic waves 120. The multi-directional and multi-position seismic waves 120 enhance the seismic coverage (or illumination) of the target region 180 and its vicinity. FIG. 4 depicts a VSP system 100 according to an embodiment including a horizontal first borehole 130. Although FIG. 4 shows four seismic sources 110, a single seismic source 110 may be used, and the single seismic source 110 (or the displayed multiple seismic sources 110) may be moved horizontally along the borehole 130 or rotated. The array of seismic sources 110 shown in FIG. 4 may be used to improve the signal redundancy and reduce the survey time.

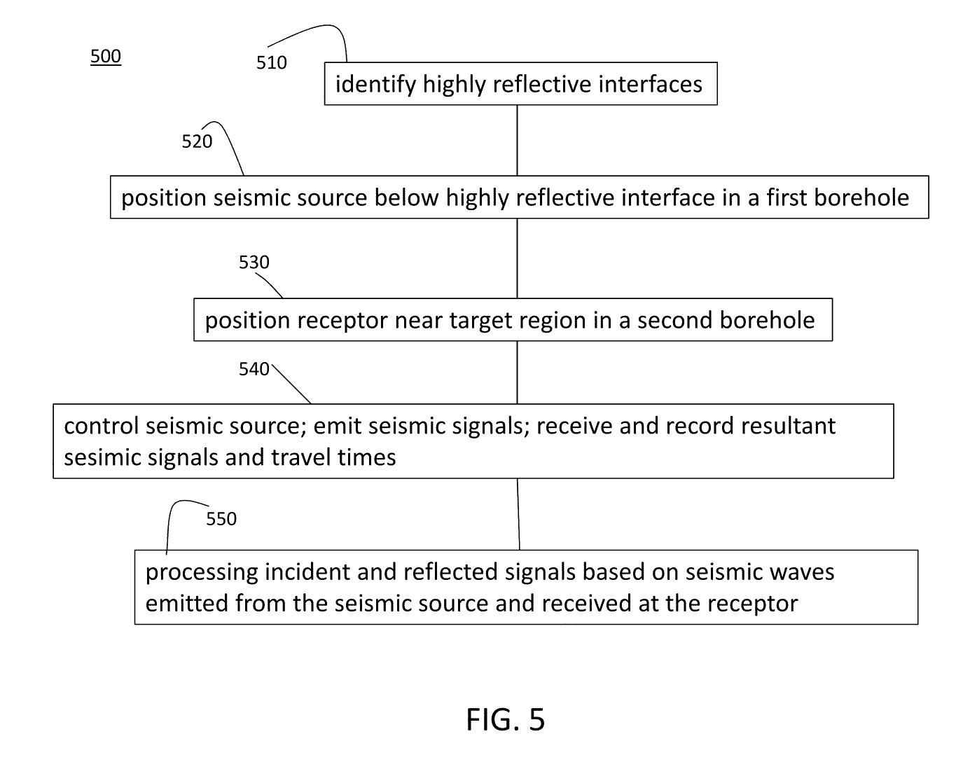

FIG. 5 depicts the processes 500 involved in obtaining a seismic profile of a target region 180 based on an embodiment. At block 510, the processes 500 include identifying one or more highly reflective interfaces 150 in the area of interest (which includes the target region 180). As discussed above, identifying a highly reflective interface 150 includes interpreting seismic data and/or well log data previously surveyed in the area. Seismic data can also be obtained with a conventional VSP survey using the seismic source 199 or the seismic source 110 to identify relatively higher reflection amplitudes. In alternate embodiments, the reflective interface 150 may be identified through interpretation of data obtained previously from a conventional VSP survey using a seismic source 199 at the surface or close to the surface. At block 520, positioning the seismic source 110 below a highly reflective interface 150 in a first borehole 130 includes using the previously identified depth of at least one highly reflective interface 150. As noted above, more than one seismic source 110 may be used to reduce the survey time, increase the coverage of the area and the redundancy of the detected signals. Also, the one or more seismic sources 110 may be rotated in place and/or moved along the first borehole 130. At block 530, positioning a receptor 160 near the target region 180 in a second borehole 170 includes positioning the receptor 160 below a depth of the seismic source 110 in the first borehole 130. This ensures that both the down-going seismic signals and up-going primary reflected signals based on seismic signals 120 emitted by the seismic source 110 are received at the receptor 160. As noted above, more than one receptor 160 may be used. When more than one receptor 160 is used, spacing the receptors 160 equi-distantly facilitates regular sampling of signals resulting from the seismic wave 120. At block 440, controlling the seismic source 110 is done by the acquisition unit 197. Block 540 also includes the seismic source 110 emitting seismic signals 120 from the first borehole 130, receiving incident and reflected seismic signals at the receptors 160 in the second borehole 170, and recording seismic signals and their respective travel times using the acquisition unit 197. Receiving and recording resultant seismic signals and their respective travel times at block 540 refers to receiving and recording data at the receptors 160, surface receptors 165, and hydrophones 166, as needed, to perform the processing. At block 550, processing incident and reflected signals resulting from seismic waves emitted by the seismic source 110 and received by the one or more receptors 160 (and surface receptors 165, and hydrophones 166) provides VSP. As noted above, the processing may be done by one or more processors 198 in an acquisition unit 197 integrated with one or more memory devices.

In support of the teachings herein, various analysis components may be used, including a digital and/or an analog system. For example, the acquisition unit 197 may include digital and/or analog components. The VSP system 100 may have components such as the acquisition unit 197, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a non-transitory computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a power supply, magnet, electromagnet, sensor, electrode, transmitter, receiver, transceiver, antenna, controller, optical unit, electrical unit or electromechanical unit may be included in support of the various aspects discussed herein or in support of other functions beyond this disclosure. The acquisition unit 197 may have or may not have communication link (wired, wireless, optical or other) with one or more processors 198 to perform data transferring, data processing and analysis.

Additionally, the data set acquired by the apparatus and method described herein can be processed, reprocessed and/or analyzed by one or more processors 198. The processor 198, in turn, may include digital and/or analog components, one or multiple CPUs, storage media, memory, input, output, communications link (wired, wireless, optical or other), user interfaces, software programs, signal processors (digital or analog) and other such components (such as resistors, capacitors, inductors and others) to provide processing and analyses of the data set acquired and recorded by the apparatus and methods disclosed herein in any of several manners well-appreciated in the art. It is considered that these teachings may be, but need not be, implemented in conjunction with a set of computer executable instructions stored on a non-transitory computer readable medium, including memory (ROMs, RAMs), optical (CD-ROMs), or magnetic (disks, hard drives), or any other type that when executed causes a computer to process and analyze the data set provided by the present invention. These instructions may provide for processor 198 equipment operations, control, data collection, processing and analysis and other functions deemed relevant by a system designer, owner, user or other such personnel. The processor 198 may include a communication link (wired, wireless, optical, satellite or other) with one or more acquisition unit 197 to perform data transferring, data processing, analysis and supporting others aspects of the acquisition procedures of this disclosure. Alternatively, data transferring between the acquisition unit 197 and the processor 198 can be provided by portable hard drives, memory cards, Compact Disks, DVDs or other memory devices used by the industry. The processor 198 may be integrated with or separate from the acquisition unit 197.

Elements of the embodiments have been introduced with either the articles “a” or “an.” The articles are intended to mean that there are one or more of the elements. The terms “including” and “having” are intended to be inclusive such that there may be additional elements other than the elements listed. The terms “first,” “second” and “third” are used to distinguish elements and are not used to denote a particular order.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system to obtain a Vertical Seismic Profile (VSP), the system comprising:
a seismic source disposed in a first borehole at a first depth greater than an identified depth of a interface, the seismic source configured to emit seismic waves; and
one or more receptors disposed in a second borehole that includes a target region of interest, the one or more receptors configured to receive direct and reflected components of the seismic waves.

2. The system according to claim 1, wherein the seismic source is one of an explosive, an air gun, or a sparkler.

3. The system according to claim 1, wherein the identified depth is identified based on previously obtained surface seismic data.

4. The system according to claim 3, wherein the identified depth is based on a difference in amplitude values of reflections in the seismic data in a given seismic section.

5. The system according to claim 3, wherein the identified depth is based on a difference in seismic attribute values of reflections in the seismic data in a given seismic section.

6. The system according to claim 1, wherein at least two receptors are disposed in the second borehole, each of the at least two receptors being equidistantly spaced from adjacent ones of the at least two receptors.

7. The system according to claim 1, wherein the first depth of the seismic source in the first borehole is less than a depth of the one or more receptors and a depth of the target region in the second borehole.

8. A method of obtaining a Vertical Seismic Profile (VSP), the method comprising:
disposing a seismic source in a first borehole at a first depth greater than an identified depth of a reflective interface, the seismic source being configured to emit seismic waves; and
disposing one or more receptors in a second borehole that includes a target region of interest, the one or more receptors configured to receive direct and reflected components of the seismic waves.

9. The method according to claim 8, further comprising identifying the identified depth of the reflective interface based on previously obtained surface seismic data.

10. The method according to claim 9, wherein the identifying is based on a difference in relative amplitude of reflections in the seismic data in a given seismic section.

11. The method according to claim 9, wherein the identifying is based on a difference in attribute values of reflections in the seismic data in a given seismic section.

12. The method according to claim 8, further comprising disposing at least two receptors in the second borehole, each of the at least two receptors being equidistantly spaced from adjacent ones of the at least two receptors.

13. The method according to claim 8, wherein the disposing the seismic source includes the first depth in the first borehole being less than a depth of the one or more receptors and a depth of the target region in the second borehole.

14. A method of arranging a Vertical Seismic Profile (VSP) system, the method comprising:
identifying a reflective interface depth of a reflective interface in an area of interest;
positioning a seismic source at a first depth, the first depth being below the reflective interface depth in a first borehole within the area of interest; and
positioning two or more receptors in a second borehole within the area of interest, the receptors being clamped to the second borehole wall in selected positions to monitor a target region for seismic profiling.

15. The method according to claim 14, wherein the selected positions are at a depth that is greater than the first depth of the seismic source in the first borehole.

16. The method according to claim 14, wherein the identifying the reflective interface depth is based on interpreting previously obtained surface seismic data in the area of interest.

17. The method according to claim 16, wherein the interpreting includes observing a difference in amplitude values of reflections in the surface seismic data in the area of interest.

18. The method according to claim 18, wherein the interpreting includes observing a difference in attribute values of reflections in the surface seismic data in the area of interest.

19. The method according to claim 14, wherein the positioning the two or more receptors includes moving the two or more receptors along the second borehole to record seismic signals in more than one position.

20. The method according to claim 14, wherein the positioning the seismic source includes moving the seismic source along the first borehole to emit a seismic wave at more than one position.

21. The method according to claim 14, wherein the positioning the seismic source includes rotating the seismic source to emit a seismic wave in more than one direction.
